(19) United States
(12) Patent Application Publication
(10) Pub. No.: US 2020/0188232 A1
(43) Pub. Date: Jun. 18, 2020

(54) Medicine extraction control system

(71) Applicant: Nathan Posner, Forest Hills, NY (US)

(72) Inventor: Nathan Posner, Forest Hills, NY (US)

(21) Appl. No.: 16/797,684

(22) Filed: Feb. 21, 2020

Related U.S. Application Data
(60) Provisional application No. 62/809,145, filed on Feb. 22, 2019.

(51) Int. Cl. A61J 7/00; A61J 1/03

(52) U.S. Cl. CPC A61J 7/0076; A61J 1/03

(57) ABSTRACT

The present invention is directed to a novel pill dispensing container that dispenses a limited number of pills in easy, safe, and hygienic manner. The pill dispensing container in accordance with the present invention comprises a cylindrical body having a closed bottom and an open mouth. A platform insert is mounted near the open mouth, parallel to the closed bottom, wherein the platform insert divides the container body in an upper compartment and a lower compartment. A platform insert is having a cutout of shape and size such that one or more pills may pass through the cutaway between the upper compartment and the lower compartment.

### CROSS-REFERENCE TO RELATED APPLICATIONS

This application claims priority to the U.S. provisional patent application Ser. No. 62/809,145, filed Feb. 22, 2019 title “Prescription medicine extraction control system” which is incorporated herein by reference in its entirety.

### FIELD OF INVENTION

The present invention relates to a container, in particular, to a pill container which can also be used as a pill dispenser.

### BACKGROUND

Pill container are known in the art for retaining a plurality of pills. The pills hereinafter refer to pharmaceutical tablets and capsules. The container generally has a cylindrical body with a mouth and a cap closing the mouth. A plurality of doses of medicine may be retained in a container. For example, prescription, vitamin, and mineral pills in numerous doses are also available in container. Pharmacist usually dispense pills in a plastic container.

To pick one or more pills from the container, generally a user tries to insert one or two fingers into the container and grab a pill. However, most of the commercially available containers generally have a narrow mouth making it difficult to insert fingers for picking a pill and the pills are out of reach. Alternate method is to pour a limited number of pills out of the container and pick the desired number of pills from the limited number of pills. The remaining pills can be then be returned to the container. The above method has a drawback that one or more pills may spill from the container and get lost. The fallen pills may also get contaminated and must be discarded. Therefore, it will be appreciated that there exists a continuing need for a new and improved pill container which can be used for receiving and retaining a plurality of pills and for dispensing a limited number of pills in a safe and hygienic manner.

### SUMMARY OF THE INVENTION

The principal objective of the present invention is therefore directed to a novel pill dispensing container that can receive and retain a plurality of pills and can dispense a limited number of pills.

It is an additional objective of the present invention to dispense the pills in a safe and hygienic manner.

It is still an additional objective of the present invention to reduce the chances of accidental spillage of the pills.

It is another objective of the present invention to aid elderly people in drawing the limited number of pills from the container.

It is still another objective of the present invention that the pill dispensing container is easy to use.

It is a further objective of the present invention to easily fill and return the pills to the bottom of the container.

It is yet another objective of the present invention that the pill dispensing container is economic to manufacture.

In one aspect, the present invention is directed to a novel pill dispensing container that is devoid of the drawbacks of the known pill containers. The pill dispensing container in accordance with the present invention comprises a container body having a closed bottom and an open mouth. A platform insert is mounted near the open mouth, parallel to the closed bottom, wherein the platform insert divides the container body into an upper compartment and a lower compartment. A platform insert is having a cutout shaped and sized such that one or more pills may pass through the cutaway between the upper compartment and the lower compartment.

In one aspect, the present invention is directed to a method of dispensing limited number of pills in a safe, easy, and hygienic manner. The method comprises a step of receiving and retaining a plurality of pills in the lower compartment of the container body. In order to dispense the limited number of pills, the pills contained in the lower compartment can be transferred onto the platform insert. In order to transfer the pills from the lower compartment onto the platform insert, face the bottom of the container at approximately 2 or 11 o'clock, and thereafter rotate the container such that the cutout portion of the platform insert is on top, thereafter, shake the container a little resulting in the pills being transferred to the topside of the platform insert. Now flip the container back to the upright position, bottom of vial facing the floor. The pills are now available much closer to the opening of the container allowing for easy removal of the pills. The limited number of pills are retained onto the platform insert in the upper compartment. To pick one or more pills, the cap is removed from the container body and the one or more pills can then be picked from the upper platform insert.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a top and side perspective view of the pill dispensing container in accordance with an embodiment of the present invention.

FIG. 2 is a top and side perspective view of a cap, in accordance with an embodiment of the present invention.

FIG. 3a is a perspective view of a platform insert, in accordance with an embodiment of the present invention.

FIG. 3b is a perspective view of the container having threads on inner surface, in accordance with an embodiment of the present invention.

FIG. 4a is a perspective view of the platform insert, according to an alternate embodiment of the present invention.

FIG. 4b is a perspective view of the container, in accordance with an alternate embodiment of the present invention.

FIG. 5 is a top view of a pill dispensing container showing another exemplary embodiment of the platform insert, in accordance with an embodiment of the present invention.

FIG. 6 is a top view of a pill dispensing container showing another exemplary embodiment of the platform insert, in accordance with an embodiment of the present invention.

FIG. 7 is a top view of a pill dispensing container showing another exemplary embodiment of the platform insert, in accordance with an embodiment of the present invention.

FIG. 8 is a top view of a pill dispensing container showing a rotation axis, in accordance with an embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

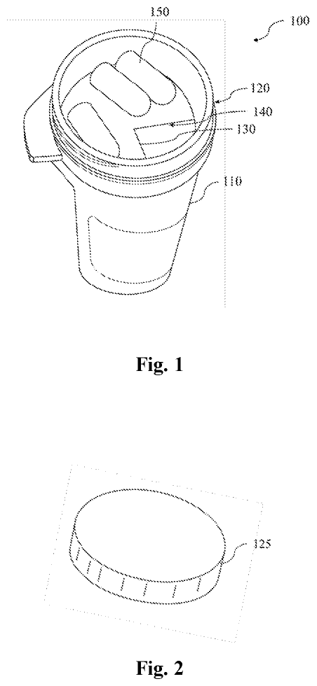

The present invention is directed to a novel pill dispensing container for receiving and retaining a plurality of pills and dispensing a limited number of pills in a safe, easy and hygienic manner. An exemplary embodiment of the pill dispensing container is shown in FIG. 1. The pill dispensing container 100 comprises a container body 110 having a closed bottom, an upright wall, and an open mouth. While, the container body is shown in FIG. 1 is cylindrical, it is within the scope of the present invention to have the container body of different sizes. The container body can be made of any material obvious to a skilled person for manufacturing containers for pharmaceutical pills. It will be appreciated that the container body can be made of glass, plastic, and metal. Moreover, the container body of different colors, such as white, amber, and like are within the scope of the present invention. It will also be appreciated that the material of the container body should be approved by a concerned drug controlling authority. The bottom of the container body can be flat or curved. The edges between the wall and the bottom can be prominent or rounded. Also, the wall of the container body be upright, or tapered such that top is wider than the bottom. Thus, different shapes of the container body are within the scope of the present invention.

The top portion of the container body 110 has a neck 120, wherein the neck 120 is configured to be coupled to a cap 125 (shown in FIG. 2). The neck 120 shown in FIG. 1 is threaded, and thus cap 125 also has the corresponding threads and can be screwed to the container body 110. While it is shown that the cap is screwed to the container, it is possible that other techniques for coupling a cap to a container can be provided, for example, a cap can be snap fit to a container. Furthermore, as can be seen in FIG. 1, a platform insert 130 is positioned just below the neck 120. The platform insert 130 divides the container body 110 into an upper compartment (above the platform insert 130) and a lower compartment (below the platform insert 130). The lower compartment receives and retains a plurality of pills. The volume of the lower compartment can be varied based on the number of pills likely to be retained in the container body 110. The volume of the upper compartment should be enough to receive at least one pill. In one case, the volume of the upper compartment can accommodate a limited number of pills. The platform insert 130 can be mounted at a predetermined height from the bottom and parallel to it. To fix the platform insert 130 to inner surface of the wall of the container body 110, the inner surface of the wall can be configured with threads, wherein the platform insert 130 can be screwed to the wall. The container body 110 can be tapered larger on top, and smaller on the bottom. In another case, the platform insert 130 can have a diameter equal to or slightly larger than that of an inner diameter of the container body 110, wherein the platform insert 130 under force can be snugly inserted and retained to the wall of the container body 110. In another case, an indent can be provided in the wall of the container body 110 to which the platform insert 130 can be retained. In another case, an outward groove can be provided in the wall to retain the platform insert 130. Yet in another case, the platform insert 130 can be sonic welded to the inner surface of wall of the container body 110.

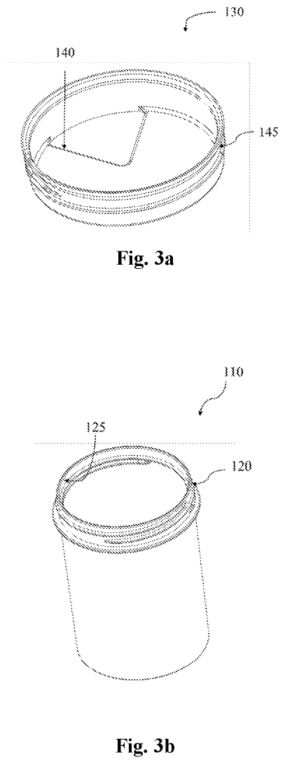

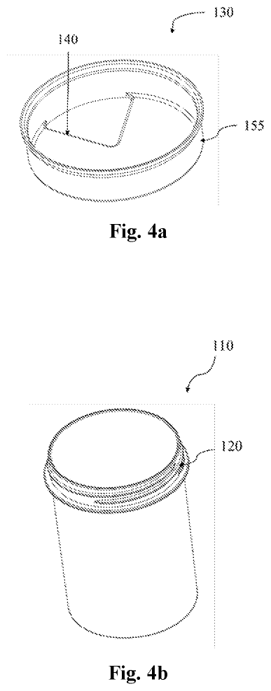

The platform insert 130 is shown to have a conical shaped cutout 140 through which pills can transfer between the upper compartment and the lower compartment. The shape and size of the cutout 140 can be varied according to the shape and size of the pill. FIG. 3a shows an embodiment of the platform insert 130 having a round base and a skirt extending upwards along the perimeter of the round base. The base is having a pie shape cut out 140 along the perimeter of the base. The outer surface of the skirt 145 is threaded, wherein platform insert 130 screws into the container body 110. An embodiment of the container 110 is shown in FIG. 3b as having the neck 120. The inner surface of the neck 120 is having the threads 125 for coupling the platform insert 130. The platform insert 130 can be screwed into the container 110, wherein the threads 145 and 125 are complementary to each other. FIG. 4a shows another embodiment of the platform insert 130 having flat outer surface 155 of the skirt. The platform insert 130 of FIG. 4a can be mounted to a container having a smooth inner surface. An embodiment of the container body 110 is shown in FIG. 4b having a smooth inner surface. The platform insert 130 can be received into the container body 110, wherein the platform insert 130 can be snugly received into the container body 110. The platform insert 130 can be snugly retained to the wall of the container body 110. The platform insert 130 which is positioned into the container body 110 having a smooth inner surface, the platform 130 can be mounted using sonic welding to couple the platform 130 to inner wall of the container body 110.

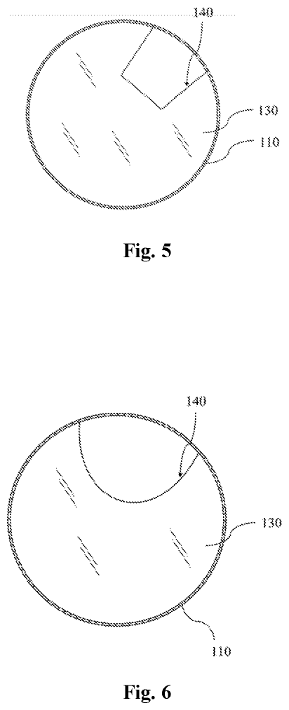

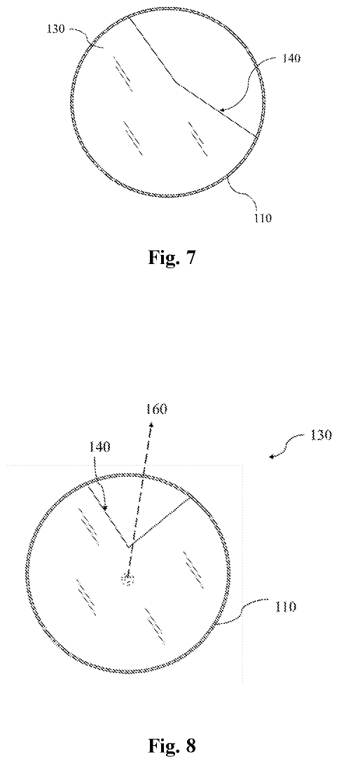

FIG. 5 shows a top view of the container body 100 showing the platform insert 130 having a substantially trapezium-shaped cutout 140. FIG. 6 shows an alternate embodiment of the platform insert 130 having a curved-shape cutout 140. FIG. 7 shows an alternate embodiment of the platform insert 130 having a bigger size cutout 140. The bigger size cutout may allow more pills to pass through at a time, while a smaller size cutout may allow only one pill to pass through at a time. A bigger size of cutout may allow fewer pills available on the platform insert 130 for removal. While a smaller cutout may allow greater pills available for removal. Thus, it is within the scope of the present invention to optimize the shape and size of the cutout according to the shape and size of the pill and the number of pills likely to pass through the cutout at a time.

FIG. 1 shows three pills retained in the upper compartment. The lower compartment stores numerous doses of pills. The pills can be filled into the lower compartment by inserting through the cutout 140. Alternatively, the pills can be retained in the lower compartment and thereafter the platform 130 stays fixed in position. To remove a limited number of pills from the container body 110, the container body 110 can be rotated 360 degrees wherein the pills from the lower compartment pass through the cutout 140 and lands on the platform insert 130. FIG. 8 shows a top view of the pill dispensing container 100 having the container body 110, a platform insert 130 and a cutout 140. Further is shown in FIG. 8 is a rotation axis 160 pointing from the center of the platform insert 130 towards the cutout 140. The capped pill dispensing container 100 is held upright with the cap facing upwards. Thereafter the pill dispensing container 100 is rotated in the direction of the rotation axis 160 i.e. in the direction of the cutout 140. While rotating the pill dispensing container 100, the pills pass through the cutout 140 from the lower compartment to the upper compartment. Once the pill dispensing container 100 is in an inverted position, the limited number of pills pass from the lower compartment to the upper compartment. The rotation of the pill dispensing container 100 can be continued in the same direction until it is back to the upright position, which causes the limited number of pills to be retained on the platform insert 130. To remove the pills, the cap can be removed, and the desired number of pills can be removed from the platform insert 130. As shown in FIG. 1, three pills 150 are retained on the platform insert 130 and from these, one to three pills can be removed by a user. The remaining pills can be returned to the lower compartment or retained on the platform insert 130 for later use.

In an alternate embodiment, an alternate method is provided to remove limited number of pills from the pill dispensing container 100. The capped pill dispensing container 100 can be tilted in the horizontal position with the cut-out portion of the platform insert 130 faces upwards i.e. the rotation axis 160 of FIG. 8 faces upwards while the container lies in horizontal position. Thereafter, the pill dispensing container can be shaken slightly up and down, and side to side to cause the limited number of pills to be transferred from the lower compartment to the upper compartment. Once the limited number of pills are transferred to the upper compartment, the pill dispensing container 100 can be flipped back to the upright position, while the limited number of pills are retained on the platform insert 130. The one or more pills can be picked by the user from the limited number of pills retained on the platform insert 130 and the remaining pills can be returned to the lower compartment.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A pill dispensing container comprising:
a container body having a closed bottom, an upright wall extending from the bottom and an open mouth, the closed bottom and the upright wall defining volume of the container body;
a cap configured to removably close the open mouth of the container body; and
a platform insert mounted into the container body at a predetermined height from the closed bottom and parallel to it, the platform insert dividing the volume of the container body into an upper compartment and a lower compartment, the platform insert is having a cutout along its perimeter for allowing one or more pills to pass through it between the upper compartment and the lower compartment.

2. The pill dispensing container of claim 1, wherein the container body is of cylindrical shape and the cap is screwed to the container body.

3. The pill dispensing container of claim 1, wherein the cutout is of conical shape.

4. The pill dispensing container of claim 1, wherein the cutout is of rectangular shape.

5. The pill dispensing container of claim 1, wherein the cutout is of curve shape.

6. The pill dispensing container of claim 1, wherein the cutout is of a size to allow predetermined number of pills to pass through it at a time.

7. The pill dispensing container of claim 1, wherein the lower compartment receives and retains a plurality of pills.

8. The pill dispensing container of claim 1, wherein the upper compartment is of a size to receive and retain at least one pill.

9. The pill dispensing container of claim 1, wherein an inner surface of the upright wall is configured with threads, wherein the platform insert is screwed to the threads.

10. The pill dispensing container of claim 1, wherein diameter of the platform insert is such as the platform insert is snugly received into the pill dispensing container and locked into position to the upright wall, wherein an inner surface of the upright wall is smooth.

11. The pill dispensing container of claim 10, wherein the platform insert is further supported by sonic welding coupling the platform insert to the inner surface of the upright wall.

12. A method of dispensing at least one pill, the method comprising:
providing a pill dispensing container, the pill dispensing container comprising:
a container body having a closed bottom, an upright wall extending from the bottom and an open mouth, the closed bottom and the upright wall defining volume of the container body,
a cap configured close to the open mouth of the container body, and
a platform insert mounted into the container body at a predetermined height from the closed bottom and parallel to it, the platform insert dividing the volume of the container body into an upper compartment and a lower compartment, the platform insert is having a cutout along its perimeter for allowing one or more pills to pass through it between the upper compartment and the lower compartment, the lower compartment retaining a plurality of pills;
positioning the capped pill dispensing container in an upright position with the cap facing upwards;
rotating the pill dispensing container in the direction of the cutout to an inverted position, causing one or more pills of the plurality of pills to pass through from the lower compartment to the upper compartment;
returning the pill dispensing container back to the upright position by further rotating the pill dispensing container in the same direction, causing the one or more pills to land on the platform insert;
removing the cap while the pill dispensing container is in the upright position; and
removing a desired number of pills from the one or more pills on the platform insert.

13. The method of claim 12, wherein an inner surface of the upright wall is configured with threads, wherein the platform insert is screwed to the threads.

14. The pill dispensing container of claim 12, wherein diameter of the platform insert is such as the platform insert is snugly received into the pill dispensing container and locked into position to the upright wall, wherein an inner surface of the upright wall is smooth.

15. The method of claim 14, wherein the platform insert is further supported by sonic welding coupling the platform insert to the inner surface of the upright wall.
